(19) United States
(12) Patent Application Publication
(10) Pub. No.: US 2026/0287961 A1
(43) Pub. Date: Sep. 24, 2026

(54) ELECTRONIC PAPER, DISPLAY APPARATUS, AND DISPLAY CONTROL METHOD

(71) Applicants: Beijing BOE Display Technology Co., Ltd., Beijing (CN); BOE Technology Group Co., Ltd., Beijing (CN)

(72) Inventors: Min WANG, Beijing (CN); Liguang DENG, Beijing (CN); Jinghao LIU, Beijing (CN); Jiahao BAI, Beijing (CN); Gang HUA, Beijing (CN); Junsheng CHEN, Beijing (CN); Jintang HU, Beijing (CN); Dong WANG, Beijing (CN); Liangliang PAN, Beijing (CN); Xinyu CHEN, Beijing (CN); Xinrui YU, Beijing (CN); Shaobo LI, Beijing (CN)

(21) Appl. No.: 19/700,334

(22) Filed: Jun. 7, 2026

Related U.S. Application Data
(63) Continuation of application No. 18/705,563, filed on Jul. 25, 2023.

(51) Int. Cl. G02F 1/167; G02F 1/16757; G02F 1/16766; G02F 1/1685; G09G 3/34

(52) U.S. Cl. CPC G02F 1/167; G02F 1/16757; G02F 1/16766; G02F 1/1685; G09G 3/344; G09G 2300/0473; G09G 2300/0842; G09G 2330/021

(57) ABSTRACT

An electronic paper includes a base substrate, and a plurality of pixel units each including a pixel driver circuit and a display unit. The display unit includes a first electrode, an electronic ink layer, and a second electrode arranged in a stack. The electronic ink layer includes a plurality of microcapsules or a plurality of microcups. Pixel driver circuits of pixel units in a same column are connected to a same data line. The plurality of pixel units are divided into a plurality of pixel unit groups each including multiple pixel units arranged side by side in a row direction and/or a column direction. The electronic paper includes a plurality of first connection pads on the base substrate. Data lines connected to at least two columns of pixel driver circuits connected to different gate lines are connected to a same first connection pad.

### CROSS-REFERENCE TO RELATED APPLICATION

This is a continuation application of a National Phase Application No. Ser. No. 18/705,563 filed on Apr. 28, 2024, which is filed under 35 U.S.C. 371 as a national stage of PCT/CN2023/109089 filed on Jul. 25, 2023, the content of each of which is hereby incorporated by reference in its entirety.

### TECHNICAL FIELD

The present disclosure relates to the field of display technology, and specifically relates to an electronic paper, a display apparatus, and a display control method.

### BACKGROUND

An electronic shelf label (ESL), i.e., electronic price tag, can be implemented mainly by a cholesterol liquid crystal display technology, an electrophoretic display (EPD) technology, an electrowetting display technology, or the like. Currently, the driver circuit for an EPD panel usually adopts a one-to-one drive mode, which means that one gate line (Gate) and one data line (Data) drive one pixel unit. For example, as shown in FIG. 1, the EPD panel has a resolution of M(Data)×N(Gate), so at least M data pins and N gate pins are required in the integrated circuit (IC) for driving.

However, in the manufacturing process of the electronic paper, the cost of a gate IC is about ¼ of the cost of a source IC. In other words, in the conventional one-to-one drive mode, a large number of source IC pins are required, resulting in high cost of the source IC and thus increased cost of the electronic paper, and unfavorably affecting the market application of the electronic paper.

### SUMMARY

To solve at least one of the technical problems in the existing art, the present disclosure provides an electronic paper, a display apparatus, and a display control method.

In a first aspect, a technical solution adopted to solve the technical problem of the present disclosure is an electronic paper, including a base substrate, and a plurality of pixel units on the base substrate and arranged in an array; wherein each pixel unit includes a pixel driver circuit and a display unit; the display unit includes a first electrode, an electronic ink layer, and a second electrode arranged in a stack; the electronic ink layer includes a plurality of microcapsules or a plurality of microcups each containing several charged particles of a plurality of colors; and the pixel driver circuit in each pixel unit is electrically connected to the first electrode of the display unit in the pixel unit; wherein
pixel driver circuits of pixel units in a same column are connected to the same data line, and pixel driver circuits of pixel units in different columns are connected to different data lines;
the plurality of pixel units are divided into a plurality of pixel unit groups arranged in an array; pixel driver circuits in a same pixel unit group are connected to different gate lines; and
the electronic paper includes a plurality of first connection pads on the base substrate; and data lines connected to at least two columns of pixel driver circuits connected to different gate lines are connected to a same first connection pad.

In some embodiments, each pixel unit group includes n pixel units arranged side by side in a row direction, where n≥2, and n is a positive integer; and
for pixel units in a same row, the pixel driver circuit of an i^{th} pixel unit in each pixel unit group is electrically connected to a same gate line, where i is a positive integer selected from 1 to n.

In some embodiments, the pixel driver circuits in each pixel unit group are staggered in a column direction.

In some embodiments, the pixel driver circuit is located in a non-display area of the pixel unit; and
for pixel units in a same row, centers of non-display areas with the pixel driver circuits connected to a same gate line are located on a same straight line extending in a row direction.

In some embodiments, data lines connected to pixel driver circuits of pixel unit groups in a same column are connected to a same first connection pad.

In some embodiments, a part of data lines connected to pixel driver circuits of pixel unit groups in a same column are connected to a same first connection pad.

In some embodiments, every two adjacent data lines in a row direction are connected to the same first connection pad.

In some embodiments, the pixel driver circuit includes at least one transistor and a storage capacitor; the storage capacitor includes a first plate and a second plate disposed opposite to each other; and
for any one of the pixel units, the first electrode of the display unit is electrically connected to the first plate of the storage capacitor.

In some embodiments, the electronic paper includes a first conductive layer, a semiconductor layer, and a second conductive layer sequentially arranged on the base substrate; and
for any one of the pixel units, a control pole of the transistor is located in the first conductive layer; an active layer of the transistor is located in the semiconductor layer; and a first pole and a second pole of the transistor are located in the second conductive layer.

In some embodiments, for any one of the pixel units, the first plate of the storage capacitor is located in the second conductive layer; and the second plate of the storage capacitor is located in the first conductive layer.

In some embodiments, for any one of the pixel units, the second plate of the storage capacitor is divided into a first subsection and a second subsection;
for a pixel units in a same row, first subsections of second plates of respective storage capacitors form an integral structure; and second subsections of the second plates of the respective storage capacitors form an integral structure; and
for all the pixel units, the integrally formed first subsections and the integrally formed second subsections are connected to a same first common signal line.

In some embodiments, for pixel units in a same row, second plates of respective storage capacitors form an integral structure; and
for all the pixel units, the integrally formed second plates are connected to a same second common signal line.

In some embodiments, for any one of the pixel units, the first plate of the storage capacitor is located in the first conductive layer; and the second plate of the storage capacitor is located in the second conductive layer.

In some embodiments, second plates of respective storage capacitors of pixel units in a same column form an integral structure; and
for the pixel units, the integrally formed second plates are connected to a same third common signal line.

In some embodiments, for any one of the pixel units, the second electrode of the display unit is disposed on a side of the first electrode away from the base substrate, and the second electrode of the display unit is electrically connected to the second plate of the storage capacitor through a second connection via.

In some embodiments, the electronic paper further includes a third conductive layer on a side of the second conductive layer away from the base substrate; and
for any one of the pixel units, the first electrode of the display unit is located in the third conductive layer.

In some embodiments, for pixel units in a same row, second electrodes of respective display units are in a same layer and form an integral structure.

In a second aspect, an embodiment of the present disclosure further provides a display apparatus, including the electronic paper according to the first aspect.

In a third aspect, an embodiment of the present disclosure further provides a display control method applied to the electronic paper according to the first aspect; wherein the display control method includes:
for pixel units in a same row, sequentially scanning, and applying a first voltage to, gate lines one by one, and applying, when one of the gate lines is scanned, a third voltage to another gate line, wherein the another gate line is a gate line scanned before the gate line currently scanned; and
when different gate lines are scanned, applying different second voltages to data lines connected to pixel driver circuits connected to different gate lines, so that first electrodes of respective display units receive the second voltages, to drive charged particles with charging property the same as the second voltages to move towards second electrodes of the display units.

In some embodiments, the different second voltages include voltages in at least three different voltage ranges of 10V to 15V, 5V to 8V, and −10V to −15 V.

### BRIEF DESCRIPTION OF DRAWINGS

FIG. 1 is a schematic diagram of a conventional pixel driver circuit;

FIG. 2a is a schematic structural diagram of an electronic paper according to an embodiment of the present disclosure;

FIG. 2b is a schematic structural diagram of a pixel unit according to an embodiment of the present disclosure;

FIG. 3 is a schematic plan view of a plurality of pixel units arranged in an array according to an embodiment of the present disclosure;

FIG. 4 is another schematic plan view of a plurality of pixel units arranged in an array according to an embodiment of the present disclosure;

FIG. 5 is another schematic plan view of a plurality of pixel units arranged in an array according to an embodiment of the present disclosure;

FIG. 6 is a schematic plan view of a pixel driver circuit according to an embodiment of the present disclosure;

FIG. 7 is another schematic plan view of a pixel driver circuit according to an embodiment of the present disclosure;

FIG. 8 is another schematic plan view of a pixel driver circuit according to an embodiment of the present disclosure;

FIG. 9 is another schematic plan view of a pixel driver circuit according to an embodiment of the present disclosure;

FIG. 10 is a sectional view of the pixel driver circuit shown in FIGS. 6 and 8;

FIG. 11 is a sectional view of the pixel driver circuit shown in FIGS. 7 and 9;

FIG. 12 is a diagram of an equivalent circuit of a pixel driver circuit according to an embodiment of the present disclosure; and

FIG. 13 is a diagram of a timing control of a pixel driver circuit according to an embodiment of the present disclosure.

### REFERENCE CHARACTERS

1. base substrate; 2. pixel unit; 21. pixel driver circuit; 22. display unit; 41. pixel driver circuit layer; 42. display layer; 221. first electrode; 222. electronic ink layer; 223. second electrode; ITO. pixel electrode; Vcom 1. first common electrode; 222a. charged particles; TFT1. first thin film transistor; TFT2. second thin film transistor; TFT_a. first pole; TFT_b. second pole; TFT_c. control pole; TFT_d. active layer; Cst. storage capacitor; Cst_1. first plate; Cst_2. second plate; Vcom2. second common electrode; Cst_2a. first subsection; Cst_2b. second subsection; Data. data line; Gate. gate line; 3. pixel unit group; X. row direction; Y. column direction; BB. non-display area; S. first side surface; M1. first conductive layer; M2. second conductive layer; M3. third conductive layer; Active. semiconductor layer; R1. first insulation layer; R2. second insulation layer; and R3. third insulation layer.

### DETAIL DESCRIPTION OF EMBODIMENTS

To make the objects, technical solutions and advantages of the embodiments of the present disclosure more apparent, the technical solutions according to the embodiments of the present disclosure will be clearly and completely described below with reference to the drawings of the embodiments of the present disclosure. Apparently, the described embodiments are merely some, but not all, of the embodiments of the present disclosure. The components in the embodiments of the present disclosure, as generally described and illustrated in the figures herein, could be arranged and designed in a wide variety of different configurations. Therefore, the following detailed description of the embodiments of the present disclosure, provided in the accompanying drawings, is not intended to limit the scope of the present disclosure as claimed, but is merely representative of selected embodiments of the present disclosure. All other embodiments, which can be derived by those skilled in the art from the embodiments of the present disclosure without making any creative effort, shall fall within the protection scope of the present disclosure.

Unless otherwise defined, technical or scientific terms used in the present disclosure are intended to have general meanings as understood by those of ordinary skill in the art to which the present disclosure belongs. The words “first”, “second” and similar terms used in the present disclosure do not denote any order, quantity, or importance, but are used merely for distinguishing different components from each other. Also, the words “a”, “an”, or “the” and similar referents do not denote a limitation of quantity, but rather denote the presence of at least one. The word “comprising” or “including” or the like means that the element or item preceding the word contains elements or items that appear after the word or equivalents thereof, but does not exclude other elements or items. The words “connected” or “coupled” and the like are not restricted to physical or mechanical connections, but may include electrical connections, whether direct or indirect. The words “upper”, “lower”, “left”, “right”, and the like are merely used to indicate a relative positional relationship, and when an absolute position of the described object is changed, the relative positional relationship may be changed accordingly.

Reference to “a plurality of or several” in the present disclosure means two or more. The term “and/or” describes an association relationship of associated objects, which may include three relationships; for example, A and/or B may refer to: A alone, A and B, or B alone. The character “/” generally indicates that the former and latter associated objects are in an “or” relationship.

In the existing art, the electrophoretic display (EPD), which is generally implemented by microstructures such as a microcapsule structure, a microcup array structure, or the like, is most widely applied. Either the microcapsule structure or the microcup array structure forms a picture through movement of charged particles. As shown in FIG. 1, which is a schematic diagram of a conventional pixel driver circuit, a gate signal and a data signal are led out through fanout wires and input from a drive IC 01 to a module display area, to control a thin film transistor TFT in a pixel unit 02 to be turned on; and then the signal is transmitted through the tuned-on TFT to a pixel electrode which forms a vertical electric field with a common electrode on a paper film. The resulting vertical electric field forms a target picture by driving charged particles in the paper film to move.

However, the driver circuit for an EPD panel usually adopts a 1G1D drive mode, as shown in FIG. 1. In the manufacturing process of the electronic paper, the cost of a gate IC is about ¼ of the cost of a source IC. In other words, in the conventional 1G1D drive mode, a large number of source IC pins are required, resulting in high cost of the source IC and thus increased cost of the electronic paper, and unfavorably affecting the market application of the electronic paper.

In view of this, an embodiment of the present disclosure provides an electronic paper, in which, a plurality of data lines are connected to a same first connection pad. This method of driving multiple columns of pixel units by the same data signal reduces the number of source IC pins; and meanwhile, the bistable characteristic of the EPD and the characteristic of the gate IC controlling a thin film transistor (TFT) switch in a pixel driver circuit by a gate signal is utilized so that multiple columns of pixel units controlled by the same data signal can display different and more exquisite pictures, while the display effect is optimized.

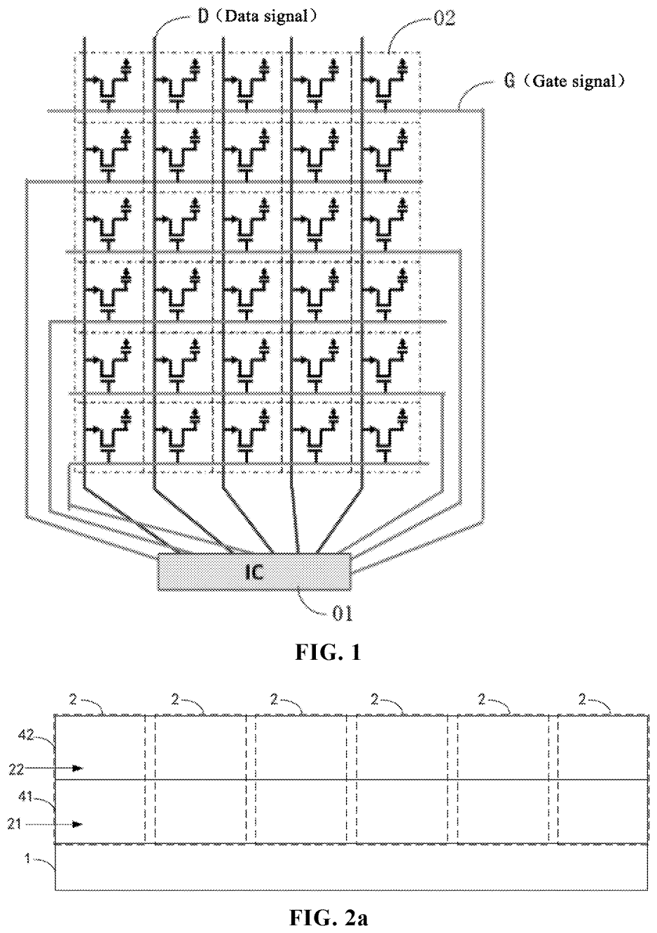

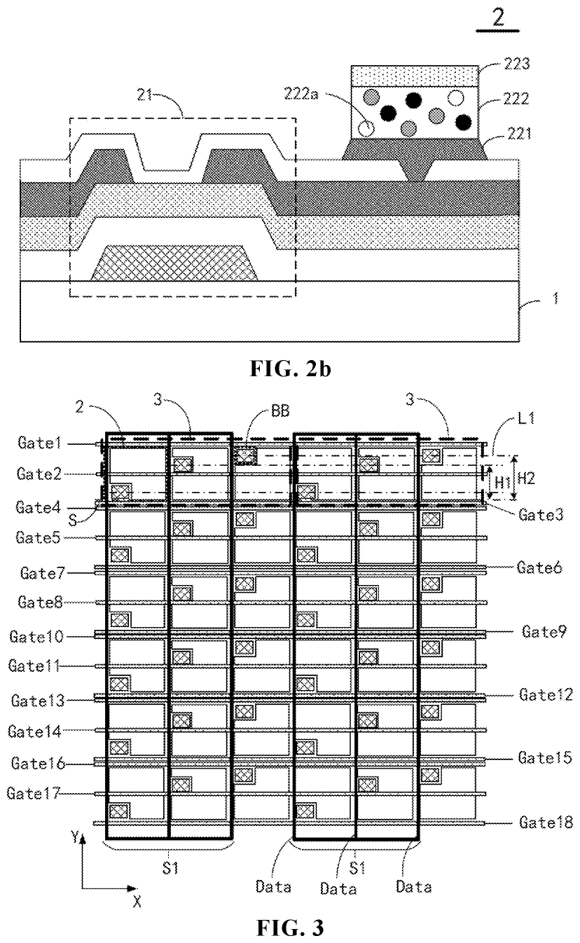

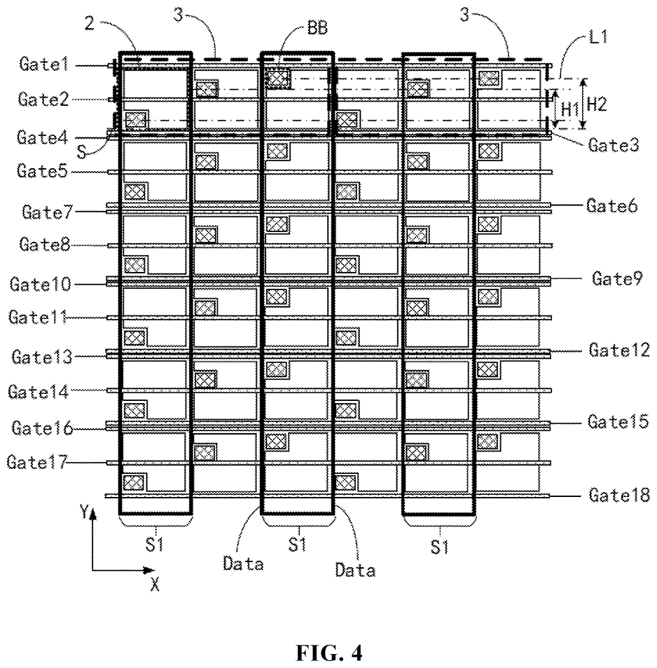

The following provides a detailed description of the specific structure of an electronic paper according to an embodiment of the present disclosure. FIG. 2a is a schematic structural diagram of an electronic paper according to an embodiment of the present disclosure, FIG. 2b is a schematic structural diagram of a pixel unit according to an embodiment of the present disclosure, FIG. 3 is a schematic plan view of a plurality of pixel units arranged in an array according to an embodiment of the present disclosure, FIG. 4 is another schematic plan view of a plurality of pixel units arranged in an array according to an embodiment of the present disclosure, and FIG. 5 is another schematic plan view of a plurality of pixel units arranged in an array according to an embodiment of the present disclosure.

As shown in FIG. 2a, the electronic paper includes a base substrate 1, and a plurality of pixel units 2 on the base substrate 1 arranged in an array. Each pixel unit 2 includes a pixel driver circuit 21 and a display unit 22. The display unit 22 is disposed on a side of the pixel driver circuit 21 away from the base substrate 1. The electronic paper further includes a pixel layer on the base substrate 1. The pixel layer includes a pixel driver circuit layer 41 and a display layer 42. The plurality of pixel units 2 arranged in an array are located in the pixel layer, the plurality of pixel driver circuits 21 are all located in the pixel driver circuit layer 42, and the plurality of display units 22 are all located in the display layer 42.

As shown in FIG. 2b, the display unit 22 includes a first electrode 221, an electronic ink layer 222, and a second electrode 223 arranged in a stack. One of the first electrode 221 and the second electrode 223 is a pixel electrode ITO, and the other is a first common electrode Vcom1. For convenience of understanding, a case where the first electrode 221 is the pixel electrode ITO, and the second electrode 223 is the first common electrode Vcom1 is taken as an example for illustration in the embodiments of the present disclosure. Generally, the first common electrode Vcom1 is grounded.

The electronic ink layer 222 includes a plurality of microcapsules or a plurality of microcups containing several charged particles 222a of a plurality of colors. The pixel driver circuit 21 in each pixel unit 2 is electrically connected to the first electrode 221 of the display unit 22 in the pixel unit, to drive the display unit 22 to display a target picture.

Apparently, the microcapsules or microcups may contain a plurality of charged magnetic particles, or plasma, not limited to charged particles. The embodiments of the present disclosure are illustrated with charged particles.

By applying a voltage to the first electrode 221 and the second electrode 223, an electric field is formed, and different colors of charged particles 222a are driven to move according to different voltages currently applied, thereby displaying different colors on a surface of the electronic paper. For example, in the case of a microcapsule structure, when a negative electric field is applied across the microcapsule, negatively charged white particles are moved to a top of the microcapsule under the action of the electric field, while positively charged black particles are moved to a bottom of the microcapsule to be “hidden”, so that the surface appears white; and when a positive electric field is applied on two adjacent sides of microcapsule, black particles are moved to the top of the microcapsules under the action of the electric field, so that the surface appears black. In brief, the microcapsule structure forms a bistable state with charged particles under the action of an electric field, so that upon power break, the electronic paper can still display as before the power break.

As shown in FIGS. 3 to 5, pixel driver circuits 21 of the pixel units 2 in the same column are connected to the same data line Data, and pixel driver circuits 21 of the pixel units 2 in different columns are connected to different data lines Data. Each data line Data is electrically connected to a source IC that supplies a data signal to the pixel driver circuit 21 connected thereto through the data line Data, thereby supplying a drive voltage to the pixel electrode ITO, so that the pixel electrode ITO and the first common electrode Vcom1 form a vertical electric field.

As shown in FIGS. 3 to 5, the plurality of pixel units 2 are divided into a plurality of pixel unit groups 3 arranged in an array; and pixel driver circuits 21 in the same pixel unit group 3 are connected to different gate lines Gate. Each gate line Gate is electrically connected to a gate IC that supplies a gate signal to the pixel driver circuit 21 connected thereto through the gate line Gate, thereby controlling on/off of a transistor.

Illustratively, each pixel unit group 3 may include a plurality of pixel units 2 arranged side by side in a row direction X and/or a column direction Y. For example, as shown in FIGS. 3 to 5, one pixel unit group 3 includes three pixel units 2 arranged side by side in the row direction X.

The electronic paper includes a plurality of first connection pads on the base substrate 1; and data lines Data connected to at least two columns of pixel driver circuits 21 connected to different gate lines Gate are connected to the same first connection pad. The first connection pads are IC pins. For an EPD panel having a resolution of M(Data)×N(Gate), the embodiment of the present disclosure can reduce at least M/3 source IC pins (first connection pads) compared with the conventional 1G1D drive mode, thereby saving the cost of the source IC and thus the manufacturing cost of the electronic paper.

Illustratively, as shown in FIG. 3 where two first connection pads are shown, the data lines Data connected to every three columns of pixel driver circuits 21 connected to different gate lines Gate are connected to the same first connection pad. For an EPD panel having a resolution of M(Data)×N(Gate), the embodiment of the present disclosure can reduce 2M/3 source IC pins compared with the conventional 1G1D drive mode, thereby saving the cost of the source IC and thus the manufacturing cost of the electronic paper.

Illustratively, as shown in FIGS. 4 and 5 where three first connection pads are shown, the data lines Data connected to every two columns of pixel driver circuits 21 connected to different gate lines Gate are connected to the same first connection pad. For an EPD panel having a resolution of M(Data)×N(Gate), the embodiment of the present disclosure can reduce M/3 source IC pins compared with the conventional 1G1D drive mode, thereby saving the cost of the source IC and thus the manufacturing cost of the electronic paper.

In addition, based on the electrophoretic display characteristic of the electronic paper (i.e., upon power break, the electronic paper can still display as before the power break), a plurality of gate lines Gate are sequentially scanned, and the pixel driver circuits 21 connected to the same first connection pad and different gate lines Gate can supply different drive voltages to pixel electrodes ITO of the respective display units 22 connected thereto, so that the display units 22 can display different pictures, which can improve exquisiteness of the display picture of the electronic paper while reducing the number of source IC pins.

In some embodiments, each pixel unit group 3 includes n pixel units 2 arranged side by side in the row direction X, where n≥2, and n is a positive integer; and for the pixel units 2 in the same row, the pixel driver circuit 21 of an i^{th} pixel unit 2 in each pixel unit group 3 is electrically connected to the same gate line Gate, where i is a positive integer selected from 1 to n.

Illustratively, as shown in FIGS. 3 and 4, each pixel unit group 3 includes three pixel units 2 arranged side by side in the row direction X.

Illustratively, as shown in FIG. 5, each pixel unit group 3 includes two pixel units 2 arranged side by side in the row direction X.

In this embodiment, the pixel unit 2 at the same position in each pixel unit group 3 is connected to the same gate line Gate, so that the structure is uniform, the wiring is convenient, and the wiring space is saved.

In some embodiments, as shown in FIGS. 3 to 5, the pixel driver circuits 21 in the pixel unit group 3 are staggered in the column direction Y.

In some embodiments, the base substrate 1 includes a first side surface and a second side surface disposed opposite to each other in the column direction Y. As shown in FIGS. 3 to 5, the pixel driver circuit 21 is located in a non-display area BB of the pixel unit 2; and a first distance H1 from a center of the non-display area BB where the i^{th} pixel driver circuit 21 is located in the pixel unit group 3 to a first side surface S is less than a second distance H2 from a center of the area where an (i+1)^{th} pixel driver circuit 21 is located to the first side surface S.

In some embodiments, as shown in FIGS. 3 to 5, the pixel driver circuit 21 is located in a non-display area BB of the pixel unit 2; and for the pixel units 2 in the same row, centers of non-display areas BB with the pixel driver circuits 21 connected to the same gate line Gate are located on the same straight line L1, and the straight line L1 extends in the row direction X.

In some embodiments, as shown in FIGS. 3 and 5, data lines Data connected to the pixel driver circuits 21 of pixel unit groups 3 in the same column are connected to the same first connection pad.

In combination with the above embodiments illustrating arrangement of the pixel driver circuits 21 and the gate lines Gate, in the case where the same first connection pad is used for the same pixel unit group 3, the above arrangement of the pixel driver circuits 21 and the gate lines Gate enables different pixel units 2 in the same pixel unit group 3 to display different pictures.

Illustratively, the plurality of pixel units 2 are divided into a plurality of pixel unit groups 3 arranged in an array; data lines Data connected to the pixel driver circuits 21 of pixel unit groups 3 in the same column are connected to the same first connection pad; and pixel driver circuits 21 in the same pixel unit group 3 are connected to different gate lines Gate. In this example, a plurality of gate lines Gate in one pixel unit group 3 are sequentially scanned so that the pixel driver circuits 21 in the same pixel unit group 3 connected to different gate lines Gate can supply different drive voltages to pixel electrodes ITO of the respective display units 22 connected thereto. Meanwhile, by means of the bistable characteristic of the charged particles 222a under the action of an electric field (i.e., upon power break, the electronic paper can still display as before the power break), the plurality of pixel units 2 in one pixel unit group 3 can display different pictures in the scanning process of the gate lines Gate, which can improve exquisiteness of the display picture while reducing the number of source IC pins.

In some embodiments, as shown in FIG. 4, a part of data lines Data connected to the pixel driver circuits 21 of pixel unit groups 3 in the same column are connected to the same first connection pad.

In some embodiments, as shown in FIG. 4, every two adjacent data lines Data in the row direction X are connected to the same first connection pad.

Illustratively, one pixel unit group 3 includes three pixel units 2 arranged side by side in the row direction X, where data lines Data connected to pixel driver circuits 21 in two adjacent pixel units 2 are connected to the same first connection pad, while a data line Data connected to the pixel driver circuit 21 in the rest one pixel unit 2 is connected to the same first connection pad as the data line Data connected to an adjacent pixel driver circuit 21 in an adjacent pixel unit group 3.

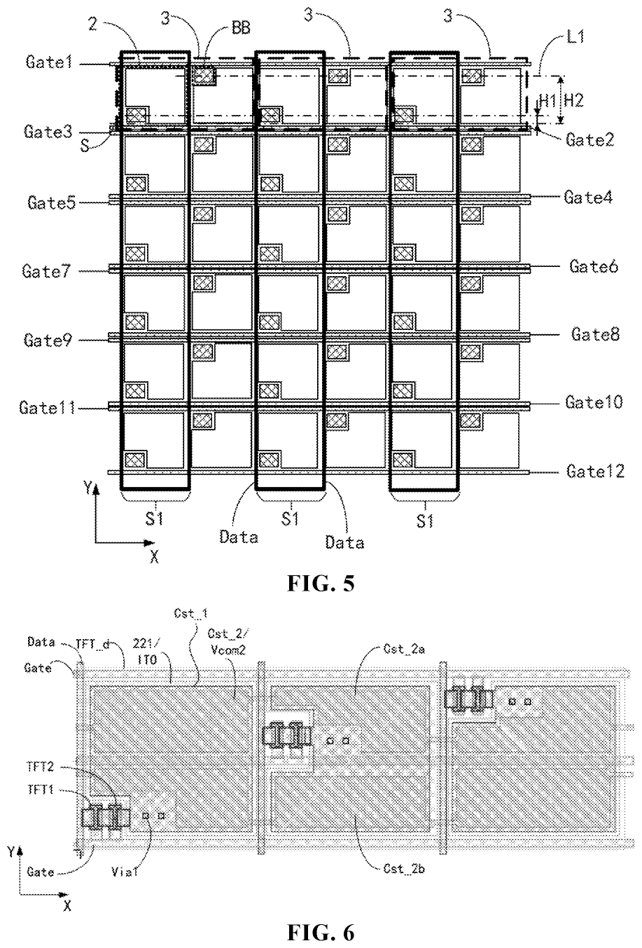

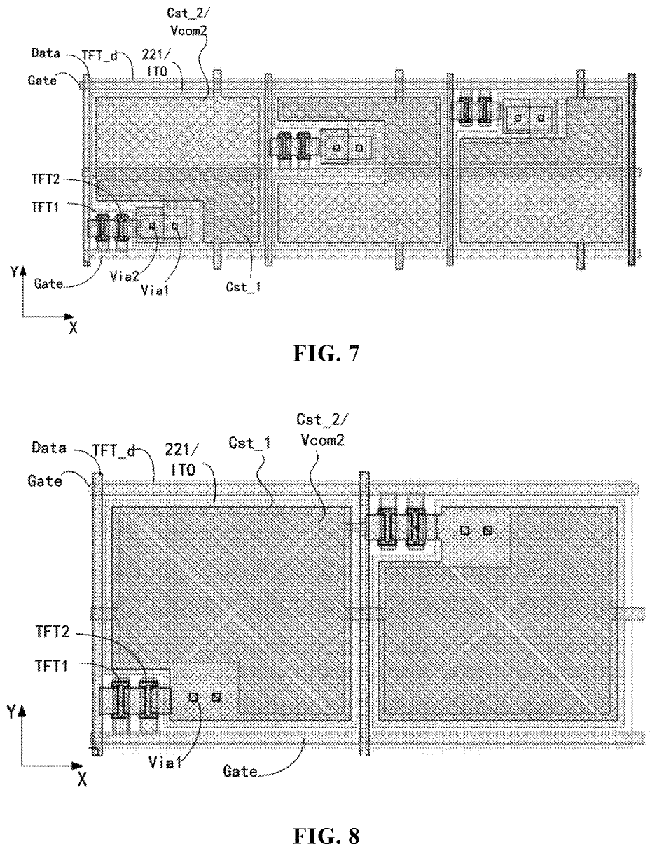

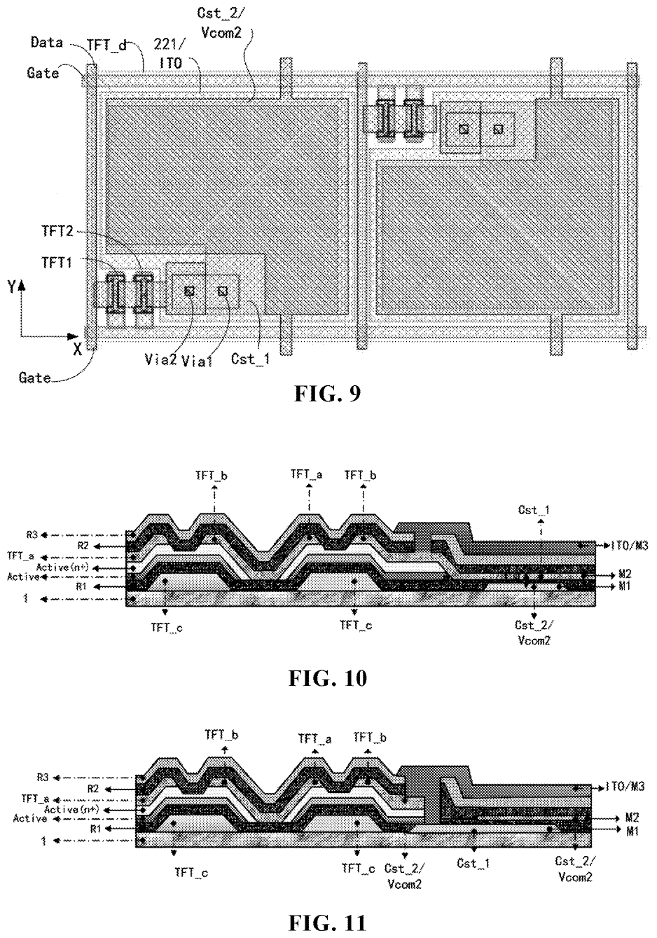

FIG. 6 is a schematic plan view of a pixel driver circuit according to an embodiment of the present disclosure, FIG. 7 is another schematic plan view of a pixel driver circuit according to an embodiment of the present disclosure, FIG. 8 is another schematic plan view of a pixel driver circuit according to an embodiment of the present disclosure, FIG. 9 is another schematic plan view of a pixel driver circuit according to an embodiment of the present disclosure, FIG. 10 is a sectional view of the pixel driver circuit shown in FIGS. 6 and 8, and FIG. 11 is a sectional view of the pixel driver circuit shown in FIGS. 7 and 9.

In some embodiments, in combination with the above embodiments and as shown in FIGS. 6 to 11, the pixel driver circuit 21 includes at least one transistor and a storage capacitor Cst. The storage capacitor Cst includes a first plate Cst_1 and a second plate Cst_2 disposed opposite to each other. For any one of the pixel units 2, the first electrode 221 of the display unit 22 is electrically connected to the first plate Cst_1 of the storage capacitor Cst. Illustratively, the first electrode 221 of the display unit 22 may be electrically connected to the first plate Cst_1 of the storage capacitor Cst through a first connection via Via1.

Illustratively, the second plate Cst_2 of the storage capacitor Cst may be a second common electrode Vcom2.

Illustratively, the second common electrode Vcom2 may be grounded.

It should be noted that the transistor used in the embodiments of the present disclosure may be a thin film transistor (TFT) or a field effect transistor or any other device with the same characteristics, and since the source and the drain of the transistor used are symmetrical, the source and the drain are exchangeable. In the embodiments of the present disclosure and the following description, in order to distinguish the source and the drain of the transistor, one of the poles is referred to as a first pole TFT_a, the other of the poles is referred to as a second pole TFT_b, and the gate is referred to as a control pole TFT_c. In addition, transistors may be classified into N-type transistors and P-type transistors according to the characteristics of the transistors. When a P-type transistor is adopted, the first pole TFT_a refers to the source of the P-type transistor, the second pole TFT_b refers to the drain of the P-type transistor, and the source and the drain are in an on state when a low level signal is input to the gate. When an N-type transistor is adopted, the first pole TFT_a refers to the source of the N-type transistor, the second pole TFT_b refers to the drain of the N-type transistor, and the source and the drain are in an on state when a high level signal is input to the gate. The embodiments of the present disclosure are specifically described taking an N-type transistor as an example.

Taking the pixel driver circuit 21 including only one thin film transistor TFT and one storage capacitor Cst as an example, the thin film transistor TFT includes a first pole TFT_a, a second pole TFT_b, and a control pole TFT_c. The first pole TFT_a is electrically connected to a data line Data. The second pole TFT_b is electrically connected to a first plate Cst_1 of the storage capacitor Cst. The control pole TFT_c is electrically connected to a gate line Gate.

As shown in FIGS. 6 to 11, taking the pixel driver circuit 21 including a first thin film transistor TFT1, a second thin film transistor TFT2 and a storage capacitor Cst as an example, the first thin film transistor TFT1 and the second thin film transistor TFT2 each include a first pole TFT_a, a second pole TFT_b, and a control pole TFT_c. A first pole TFT_a of the first thin film transistor TFT1 is electrically connected to a data line Data, a second pole TFT_b of the first thin film transistor TFT1 is electrically connected to a first pole TFT_a of the second thin film transistor TFT2, control poles TFT_c of the first thin film transistor TFT1 and the second thin film transistor TFT2 are both electrically connected to a gate line Gate, and a second pole TFT_b of the second thin film transistor TFT2 is electrically connected to a first plate Cst_1 of the storage capacitor Cst.

In some embodiments, as shown in FIGS. 10 and 11, the electronic paper includes a first conductive layer M1, a semiconductor layer Active, and a second conductive layer M2 sequentially arranged on the base substrate 1. For any one of the pixel units 2, a control pole TFT_c of the thin film transistor TFT is located in the first conductive layer M1; an active layer TFT_d of the transistor is located in the semiconductor layer Active; and a first pole TFT_a and a second pole TFT_b of the thin film transistor TFT are located in the second conductive layer M2.

The electronic paper further includes a first insulation layer R1 on a side of the first conductive layer M1 close to the semiconductor layer Active. The first insulation layer R1 may be used as a gate insulation layer to isolate the gate and the Active layer TFT_d of the thin film transistor. The electronic paper further includes a second insulation layer R2 on a side of the second conductive layer M2 away from the semiconductor layer Active. The second insulation layer R2 may be used as a passivation layer. The electronic paper further includes a third insulation layer R3 on a side of the second insulation layer R2 away from the second conductive layer M2. The third insulation layer R3 may be selected as an organic film layer to reduce the power consumption.

In some embodiments, as shown in FIGS. 6, 8 and 10, for any one of the pixel units 2, the first plate Cst_1 of the storage capacitor Cst is located in the second conductive layer M2; and the second plate Cst_2 of the storage capacitor Cst is located in the first conductive layer M1.

In combination with the above embodiments, a preparation sequence of the respective film layers includes, for example: forming a first conductive layer M1 containing a control pole TFT_c of a thin film transistor TFT and a second plate Cst_2 of a storage capacitor Cst through a patterning process; depositing an insulation layer material to form a first insulation layer R1; forming a semiconductor layer Active containing an active layer TFT_d of the thin film transistor TFT through a patterning process; forming a second conductive layer M2 containing a first pole TFT_a and a second pole TFT_b of the thin film transistor TFT and a first plate Cst_1 of the storage capacitor Cst through a patterning process; depositing an insulation layer material to form a second insulating layer R2; and depositing an insulation layer material to form a third insulation layer R3.

In some embodiments, in combination with the above embodiments and as shown in FIG. 6, for any one of the pixel units 2, the second plate Cst_2 of the storage capacitor Cst is divided into a first subsection Cst_2a and a second subsection Cst_2b. For the pixel units 2 in the same row, first subsections Cst_2a of second plates Cst_2 of respective storage capacitors Cst form an integral structure; and second subsections Cst_2b of the second plates Cst_2 of the respective storage capacitors Cst form an integral structure. For all the pixel units 2, the integrally formed first subsections Cst_2a and the integrally formed second subsections Cst_2b are connected to the same first common signal line.

Here, the first subsection Cst_2a and the second subsection Cst_2b are arranged in parallel along the column direction Y, so that the second plate Cst_2 of the storage capacitor Cst approximately covers a display area of the display unit 22, thereby increasing the storage capacitor Cst and facilitating holding of the display screen.

Illustratively, the second plates Cst_2 of the storage capacitors Cst in the respective pixel driver circuits 21 are connected to the same first common signal line. The first common signal line may be directly grounded, or may be electrically connected to the first common electrode Vcom1 and grounded through the first common electrode Vcom1.

In some embodiments, as shown in FIG. 8, for the pixel units 2 in the same row, second plates Cst_2 of respective storage capacitors Cst form an integral structure; and for the pixel units 2, the integrally formed second plates Cst_2 are connected to the same second common signal line.

Illustratively, as shown in FIG. 8, the second plate Cst_2 of the storage capacitor Cst approximately covers a display area of the display unit 22, thereby increasing the storage capacitor Cst and facilitating holding of the display screen.

Illustratively, the second plates Cst_2 of the storage capacitors Cst in the respective pixel driver circuits 21 are connected to the same second common signal line. The second common signal line may be directly grounded, or may be electrically connected to the first common electrode Vcom1 and grounded through the first common electrode Vcom1.

In some embodiments, as shown in FIGS. 7, 9 and 11, for any one of the pixel units 2, the first plate Cst_1 of the storage capacitor Cst is located in the first conductive layer M1; and the second plate Cst_2 of the storage capacitor Cst is located in the second conductive layer M2.

In combination with the above embodiments, a preparation sequence of the respective film layers includes, for example: forming a first conductive layer M1 containing a control pole TFT_c of a thin film transistor TFT and a first plate Cst_1 of a storage capacitor Cst through a patterning process; depositing an insulation layer material to form a first insulation layer R1; forming a semiconductor layer Active containing an active layer TFT_d of the thin film transistor TFT through a patterning process; forming a second conductive layer M2 containing a first pole TFT_a and a second pole TFT_b of the thin film transistor TFT and a second plate Cst 2 of the storage capacitor Cst through a patterning process; depositing an insulation layer material to form a second insulating layer R2; and depositing an insulation layer material to form a third insulation layer R3.

In some embodiments, as shown in FIGS. 7 and 9, second plates Cst_2 of respective storage capacitors Cst in the pixel units 2 of the same column form an integral structure; and for the pixel units 2, the integrally formed second plates Cst_2 are connected to the same third common signal line.

In some embodiments, as shown in FIGS. 6, 8 and 10, orthographic projections of the first plate Cst_1 and the second plate Cst_2 of the storage capacitor Cst have approximately the same coverage area, which can approximately cover the display area of the display unit 22, thereby increasing the storage capacitor Cst and facilitating holding of the display screen.

In some embodiments, the electronic paper further includes a third conductive layer M3 on a side of the second conductive layer M2 away from the base substrate 1; and for any one of the pixel units 2, the first electrode 221 of the display unit 22 is located in the third conductive layer M3.

The above preparation sequence further includes, for example: forming a third conductive layer M3 containing the first electrode 221 of the display unit 22 by a patterning process on a side of the third insulation layer R3 away from the base substrate 1; forming an electronic ink layer 222 on a side of the third conductive layer M3 away from the base substrate 1; and forming a fourth conductive layer containing the second electrode 223 of the display unit 22 by a patterning process on a side of the electronic ink layer 222 away from the base substrate 1.

Illustratively, the first conductive layer M1 further includes gate lines Gate, and the second conductive layer M2 further includes data lines Data.

In some embodiments, for any one of the pixel units 2, the second electrode 223 of the display unit 22 is disposed on a side of the first electrode 221 away from the base substrate 1, and the second electrode 223 of the display unit 22 may be electrically connected to the second plate Cst_2 of the storage capacitor Cst through a second connection via Via2.

In some embodiments, for the pixel units 2 in the same row, second electrodes 223 of respective display units 22 are in the same layer and form an integral structure.

Illustratively, the first common electrode Vcom1 and the second common electrode Vcom2 may be electrically connected by silver paste dots penetrating the connection via and grounded by a signal line.

In some embodiments, a first connection line at a position where the gate line Gate is connected to the control pole TFT_c of the thin film transistor TFT is thinned to reduce an overlap capacitance between the first connection line and the conductive layer in the pixel unit 2, thereby reducing the leakage current and the power consumption.

In some embodiments, a second connection line at a position where the data line Data is connected to the first pole TFT_a of the thin film transistor is thinned to reduce an overlap capacitance between the second connection line and the conductive layer in the pixel unit 2, thereby reducing the leakage current and the power consumption.

In addition, an embodiment the present disclosure further provides a display apparatus, including the electronic paper according to any one of the above embodiments.

In addition, an embodiment the present disclosure further provides a display control method mainly applied to display control of the electronic paper according to any of the above embodiments.

In some embodiments, the method includes, for pixel units 2 in the same row, sequentially scanning, and applying a first voltage to, gate lines Gate one by one, and applying, when one of the gate lines Gate is scanned, a third voltage to another gate line Gate, where the another gate line Gate is a gate line Gate scanned before the gate line Gate currently scanned; and when different gate lines Gate are scanned, applying different second voltages to data lines Data connected to pixel driver circuits 21 connected to different gate lines Gate, so that first electrodes 221 of respective display units 22 receive the second voltages, to drive charged particles 222a with charging property the same as the second voltages to move towards second electrodes 223 of the display units.

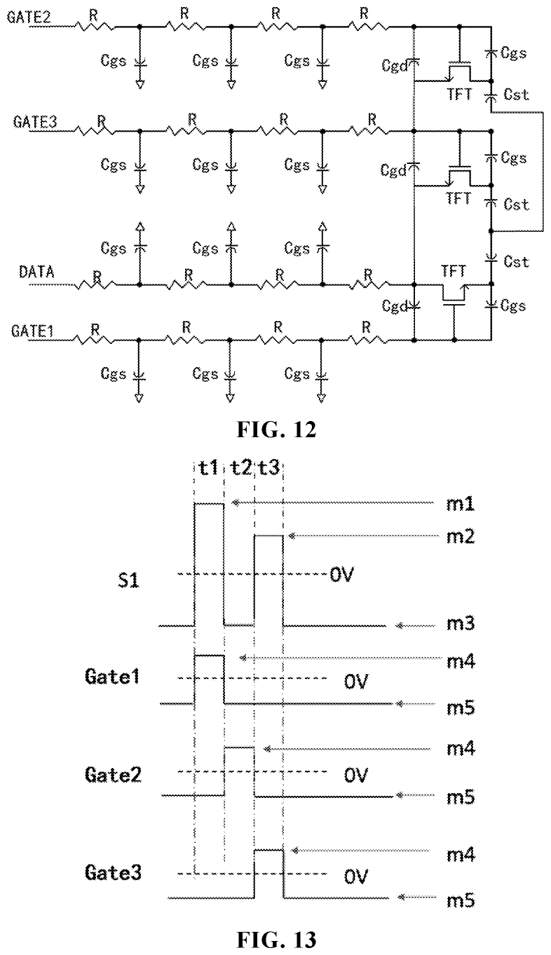

FIG. 12 is a diagram of an equivalent circuit of a pixel driver circuit according to an embodiment of the present disclosure. As shown in FIG. 12, taking the pixel driver circuit 21 including a first thin film transistor (TFT1), a second thin film transistor (TFT2) and a storage capacitor Cst as an example, a load of the fanout lead is equivalent to a 4R3C model in FIG. 12 (i.e., four resistances R and three equivalent capacitances Cgs, where the capacitance Cgs represents an overlap capacitance of the gate line and the source), the TFT is equivalent to an N-type A-Si TFT, and the storage capacitor Cst and the capacitance of the TFT itself (i.e., an overlap capacitance Cgd of the gate line and the data line) are represented by an equivalent capacitor structure. Data signals are triggered by the same data signal, and Vcom signals are triggered by the same Vcom signal. The Vcom signal is a common signal emitted from the electrically connected first common electrode Vcom1 and second common electrode Vcom2, and may be a GND signal.

FIG. 13 is a diagram of a timing control of a pixel driver circuit according to an embodiment of the present disclosure. As shown in FIG. 13, the timing control waveforms of the pixel driver circuit 21 driving the display unit 22 to display black, white and red are shown.

As shown in FIG. 3, data lines Data connected to the pixel driver circuits 21 of pixel unit groups 3 in the same column are connected to the same first connection pad. One pixel unit group 3 includes three pixel units 2 arranged side by side in the row direction X. For the pixel units 2 in the same row, S1 represents a second voltage applied to a first connection pad corresponding to each column of pixel unit groups 3; G1 represents a first voltage applied to a first gate line Gate1, G2 represents a first voltage applied to a second gate line Gate2, and G3 represents a first voltage applied to a third gate line Gate3.

As shown in FIG. 13, an operation process of the pixel driver circuit 21 is divided into: a first scanning phase t1, a second scanning phase t2 and a third scanning phase t3.

In the first scanning phase t1: a first voltage m4 is applied to a first gate line Gate1, a thin film transistor TFT is turned on, and a second voltage m1 is applied to a first connection pad corresponding to each column of pixel unit groups 3. Meanwhile, the second voltage m1 is written into the data lines Data connected to the pixel driver circuits 21 of each column of pixel unit groups 3, so that the pixel units 2 in a certain column display a first target picture.

Illustratively, the first voltage m4 is a turn-on voltage in the range of 10V to 20V.

Illustratively, in the case that the second voltage m1 is in the range of 10V to 15V, the first target picture is a black picture. Charged particles 222a having charging property the same as the second voltage m1 are black pellets.

In the second scanning phase t2: a first voltage m4 is applied to the second gate line Gate2, and meanwhile, a third voltage m5 is applied to the first gate line Gate1. Further, a second voltage m3 is applied to a first connection pad corresponding to each column of pixel unit groups 3, and meanwhile, the second voltage m3 is written into the data lines Data connected to the pixel driver circuits 21 of each column of pixel unit groups 3, so that the pixel units 2 in a certain column display a second target picture.

Illustratively, the first voltage m4 is a turn-on voltage in the range of 10V to 20V. The third voltage m5 is a turn-off voltage in the range of −10V to −20V.

Illustratively, in the case that the second voltage m3 is in the range of −10V to −15V, the second target picture is a white picture. Charged particles 222a having charging property the same as the second voltage m3 are white pellets.

In this phase t2, one column of pixel units 2 display a white picture, and since the third voltage m5 is a turn-off voltage, another column of pixel units 2 maintain the original black picture at the same time by means of the bistable characteristic of the charged particles 222a under the action of an electric field. Therefore, multiple columns of pixel units 2 can display different pictures in the scanning process of the gate lines Gate, which can improve exquisiteness of the display picture while reducing the number of source IC pins.

In the second scanning phase t3: a first voltage m4 is applied to the third gate line Gate3, and meanwhile, a third voltage m5 is applied to the second gate line Gate2. Further, a second voltage m2 is applied to a first connection pad corresponding to each column of pixel unit groups 3, and meanwhile, the second voltage m2 is written into the data lines Data connected to the pixel driver circuits 21 of each column of pixel unit groups 3, so that the pixel units 2 in a certain column display a third target picture.

Illustratively, in the case that the second voltage m2 is in the range of 5V to 8V, the third target picture is a red picture. Charged particles 222a having charging property the same as the second voltage m2 are red pellets.

In this phase t3, one column of pixel units 2 display a red picture, and since the third voltage m5 is a turn-off voltage, the rest two columns of pixel units 2 maintain the original black and white pictures respectively at the same time by means of the bistable characteristic of the charged particles 222a under the action of an electric field. Therefore, multiple columns of pixel units 2 can display different pictures in the scanning process of the gate lines Gate, which can improve exquisiteness of the display picture while reducing the number of source IC pins.

Therefore, with electrophoretic display characteristics of the electronic paper, i.e., holding the picture before power break upon power break, multiple columns of pixels controlled by the same data signal can display different pictures, the number of source IC pins can be reduced, and the display picture can be more exquisite.

Apparently, other voltage value ranges of the second voltage different from those discussed above may be selected to drive the charged particles 222a having charging property the same as the second voltage to display other colors different from those described above, form a more exquisite display picture, such as a checkerboard, and improve the display effect.

Illustratively, a specific signal transmission process of the pixel driver circuit 21 in the present disclosure includes: controlling the thin film transistor TFT to be turned on/off by a gate signal and a data signal. When the TFT is turned on by a gate signal, a data signal is transmitted to a pixel electrode ITO, and a vertical electric field is formed between the pixel electrode ITO and a first common electrode Vcom1, thereby controlling movement of multiple colors of charged particles 222a in the electronic ink layer 222.

For multiple columns of pixel units 2 connected to the same first connection pad, as shown in FIG. 4, two adjacent columns of pixel units 2 are connected to the same first connection pad. S1 represents a second voltage applied to each first connection pad; G1 represents a first voltage applied to a first gate line Gate1, G2 represents a first voltage applied to a second gate line Gate2, and G3 represents a first voltage applied to a third gate line Gate3. Similar to the control timing of the pixel driver circuit 21 shown in FIG. 13, the display units 22 in the pixel unit groups can be driven to display black, white, and red, respectively.

For multiple columns of pixel units 2 connected to the same first connection pad, as shown in FIG. 5, two adjacent columns of pixel units 2 are connected to the same first connection pad. S1 represents a second voltage applied to each first connection pad; G1 represents a first voltage applied to a first gate line Gate1, and G2 represents a first voltage applied to a second gate line Gate2. Similar to the control timing of the pixel driver circuit 21 shown in FIG. 13, the display units 22 in the pixel unit groups can be driven to display any two of black, white, and red, respectively.

It will be appreciated that the above implementations are merely exemplary implementations for the purpose of illustrating the principle of the present disclosure, and the present disclosure is not limited thereto. It will be apparent to one of ordinary skill in the art that various modifications and variations may be made without departing from the spirit or essence of the present disclosure. Such modifications and variations should also be considered as falling into the protection scope of the present disclosure.

What is claimed is:

1. An electronic paper, comprising a base substrate, and a plurality of pixel units on the base substrate and arranged in an array; wherein each pixel unit comprises a pixel driver circuit and a display unit; the display unit comprises a first electrode, an electronic ink layer, and a second electrode arranged in a stack; and the electronic ink layer comprises a plurality of microcapsules or a plurality of microcups each containing several charged particles of a plurality of colors; wherein
pixel driver circuits of pixel units in a same column are connected to a same data line; and
the electronic paper comprises a plurality of first connection pads on the base substrate; and data lines connected to at least two columns of pixel driver circuits connected to different gate lines are connected to a same first connection pad.

2. The electronic paper according to claim 1, wherein
the plurality of pixel units are divided into a plurality of pixel unit groups arranged in an array, each pixel unit group includes multiple pixel units arranged side by side in a row direction and/or a column direction; and
data lines connected to pixel driver circuits of pixel unit groups in a same column are connected to a same first connection pad.

3. The electronic paper according to claim 2, wherein each pixel unit group includes two pixel units arranged side by side in the row direction and/or the column direction.

4. The electronic paper according to claim 2, wherein each pixel unit group includes three pixel units arranged side by side in the row direction and/or the column direction.

5. The electronic paper according to claim 2, wherein each pixel unit group includes four pixel units arranged side by side in the row direction and/or the column direction.

6. The electronic paper according to claim 1, wherein each pixel unit group comprises n pixel units arranged side by side in a row direction, where n≥2, and n is a positive integer; and
for pixel units in a same row, the pixel driver circuit of an i^{th} pixel unit in each pixel unit group is electrically connected to a same gate line, where i is a positive integer selected from 1 to n.

7. The electronic paper according to claim 1, wherein the pixel driver circuits in each pixel unit group are staggered in a column direction.

8. The electronic paper according to claim 7, wherein the pixel driver circuit is located in a non-display area of the pixel unit; and
for pixel units in a same row, centers of non-display areas with the pixel driver circuits connected to a same gate line are located on a same straight line extending in a row direction.

9. The electronic paper according to claim 1, wherein the pixel driver circuit comprises at least one transistor and a storage capacitor; the storage capacitor comprises a first plate and a second plate disposed opposite to each other; and
for any one of the pixel units, the first electrode of the display unit is electrically connected to the first plate of the storage capacitor.

10. The electronic paper according to claim 9, wherein the electronic paper comprises a first conductive layer, a semiconductor layer, and a second conductive layer sequentially arranged on the base substrate; and
for any one of the pixel units, a control pole of the transistor is located in the first conductive layer; an active layer of the transistor is located in the semiconductor layer; and a first pole and a second pole of the transistor are located in the second conductive layer.

11. The electronic paper according to claim 10, wherein for any one of the pixel units, the first plate of the storage capacitor is located in the second conductive layer; and the second plate of the storage capacitor is located in the first conductive layer.

12. The electronic paper according to claim 11, wherein for any one of the pixel units, the second plate of the storage capacitor is divided into a first subsection and a second subsection;
for pixel units in a same row, first subsections of second plates of respective storage capacitors form an integral structure; and second subsections of the second plates of the respective storage capacitors form an integral structure; and
for all the pixel units, the integrally formed first subsections and the integrally formed second subsections are connected to a same first common signal line.

13. The electronic paper according to claim 11, wherein for pixel units in a same row, second plates of respective storage capacitors form an integral structure; and
for all the pixel units, the integrally formed second plates are connected to a same second common signal line.

14. The electronic paper according to claim 10, wherein for any one of the pixel units, the first plate of the storage capacitor is located in the first conductive layer; and the second plate of the storage capacitor is located in the second conductive layer.

15. The electronic paper according to claim 14, wherein second plates of respective storage capacitors of pixel units in a same column form an integral structure; and
for all the pixel units, the integrally formed second plates are connected to a same third common signal line.

16. The electronic paper according to claim 9, wherein for any one of the pixel units, the second electrode of the display unit is disposed on a side of the first electrode away from the base substrate, and the second electrode of the display unit is electrically connected to the second plate of the storage capacitor through a second connection via.

17. The electronic paper according to claim 10, wherein the electronic paper further comprises a third conductive layer on a side of the second conductive layer away from the base substrate; and
for any one of the pixel units, the first electrode of the display unit is located in the third conductive layer.

18. The electronic paper according to claim 1, wherein for pixel units in a same row, second electrodes of respective display units are in a same layer and form an integral structure.

19. A display apparatus, comprising the electronic paper according to claim 1.

20. A display control method applied to the electronic paper according to claim 1, wherein the display control method comprises:
for pixel units in a same row, sequentially scanning, and applying a first voltage to, gate lines one by one, and applying, when one of the gate lines is scanned, a third voltage to another gate line, wherein the another gate line is a gate line scanned before the gate line currently scanned; and
when different gate lines are scanned, applying different second voltages to data lines connected to pixel driver circuits connected to different gate lines, so that first electrodes of respective display units receive the second voltages, to drive charged particles with charging property the same as the second voltages to move towards second electrodes of the display units,
wherein the different second voltages comprise voltages in at least three different voltage ranges of 10V to 15V, 5V to 8V, and −10V to −15V.
